(19) United States
(12) Patent Application Publication
(10) Pub. No.: US 2020/0128375 A1
(43) Pub. Date: Apr. 23, 2020

(54) UPDATING VEHICLE ELECTRONICS BASED ON MOBILE DEVICE COMPATIBILITY

(71) Applicant: GM GLOBAL TECHNOLOGY OPERATIONS LLC, Detroit, MI (US)

(72) Inventors: Bassam S. Shahmurad, Clinton Township, MI (US); Robert A. Hrabak, Sterling Heights, MI (US)

(21) Appl. No.: 16/167,179

(22) Filed: Oct. 22, 2018

(51) Int. Cl. H04W 4/50; B60K 37/02; H04W 88/02; H04L 29/06; H04R 5/02; H04W 8/24; B60K 35/00

(52) U.S. Cl. CPC H04W 4/50; B60K 37/02; H04W 88/023; H04L 63/0428; H04R 5/02; H04W 4/40; B60K 35/00; B60K 2350/357; B60K 2350/355; H04R 2499/13; H04W 8/24

(57) ABSTRACT

A system and method of configuring vehicle electronics of a vehicle for compatibility with a mobile device. The method includes querying the vehicle electronics of the vehicle for vehicle identification information; sending the vehicle identification information and mobile device identification information of the mobile device to a remote facility, wherein the mobile device is separate from the vehicle electronics of the vehicle; receiving vehicle electronics configuration information from the remote facility, wherein the vehicle electronics configuration information is selected based on the vehicle identification information and the mobile device identification information; and causing the vehicle electronics to configure one or more vehicle system modules of the vehicle electronics to operate according to the vehicle electronics configuration information.

### INTRODUCTION

The present invention relates to configuring or updating vehicle electronics of a vehicle for compatibility with a mobile device.

Vehicles include hardware and software capable of obtaining and processing various information, including information that is obtained by vehicle system modules (VSMs). Moreover, vehicles include networking capabilities and can be connected to various vehicle backend servers as well as local devices. Many vehicles can interface with mobile devices so that vehicle-device functionality can be carried out.

### SUMMARY

According to one aspect of the invention, there is provided a method of configuring vehicle electronics of a vehicle for compatibility with a mobile device, the method including: querying the vehicle electronics of the vehicle for vehicle identification information; sending the vehicle identification information and mobile device identification information of the mobile device to a remote facility, wherein the mobile device is separate from the vehicle electronics of the vehicle; receiving vehicle electronics configuration information from the remote facility, wherein the vehicle electronics configuration information is selected based on the vehicle identification information and the mobile device identification information; and causing the vehicle electronics to configure one or more vehicle system modules (VSMs) of the vehicle electronics to operate according to the vehicle electronics configuration information.

According to various embodiments, this method may further include any one of the following features or any technically-feasible combination of some or all of these features:
the vehicle electronics configuration information includes one or more audio parameters that are used for carrying out one or more audio-related functions of the vehicle electronics, and wherein the one or more audio parameters are based on the vehicle identification information and the mobile device identification information;
the vehicle electronics configuration information includes vehicle-device operating parameters;
establishing a local data connection between the mobile device and the vehicle electronics;
the querying step includes sending a vehicle identification request message to the vehicle electronics from the mobile device over the local data connection, and wherein the method further comprises receiving the vehicle identification information at the mobile device from the vehicle electronics;
the sending step is carried out by the mobile device;
the vehicle electronics configuration information is received at the mobile device, and wherein the causing step is effected by sending the vehicle electronics configuration information from the mobile device to the vehicle electronics;
the mobile device includes a vehicle management application that is used to at least partly carry out the querying step, the receiving the vehicle identification information step, and the sending step;
the mobile device identification information includes information that indicates an operating system version of the mobile device; and/or
the method is carried out in response to determining that the vehicle electronics have yet to be updated for operation with the operating system version of the mobile device.

According to another aspect of the invention, there is provided a method of configuring vehicle electronics of a vehicle for compatibility with a mobile device, the method including: establishing a local data connection between the mobile device and the vehicle electronics of the vehicle; after the local data connection between the mobile device and the vehicle electronics is established, establishing a private data channel over the local data connection, wherein the mobile device includes a vehicle management application, and wherein the vehicle management application is used to establish the private data channel over the local data connection; querying the vehicle electronics for vehicle identification information by sending a vehicle identification request message from the mobile device to the vehicle electronics over the private data channel; receiving the vehicle identification information at the mobile device from the vehicle electronics via the private data channel; sending the vehicle identification information and mobile device identification information from the mobile device to one or more remote servers; receiving vehicle electronics configuration information at the mobile device from the one or more remote servers, wherein the vehicle electronics configuration information includes one or more audio parameters that are based on the vehicle identification information and the mobile device identification information; and sending the vehicle electronics configuration information to the vehicle via the private data channel thereby causing the vehicle electronics to configure one or more vehicle system modules (VSMs) of the vehicle electronics to operate according to the vehicle electronics configuration information.

According to various embodiments, this method may further include any one of the following features or any technically-feasible combination of some or all of these features:
the local data connection is established using a short-range wireless communications (SRWC) protocol;
the private data channel is established using security information that is sent to the mobile device from the one or more remote servers; and/or
communications sent over the private data channel are encrypted using a first security layer and a second security layer, wherein the first security layer is achieved via encryption or other security technique used according to the SRWC protocol, and wherein the second security layer is achieved via encryption by the vehicle management application using the security information.

According to yet another aspect of the invention, there is provided a method of configuring vehicle electronics of a vehicle for compatibility with a mobile device, wherein the method is carried out by the vehicle electronics of the vehicle, and wherein the method includes: sending vehicle identification information of the vehicle to one or more remote computers that are configured to query one or more databases for vehicle electronics configuration information based on the vehicle identification information and a mobile device software version of the mobile device, wherein the mobile device is paired or otherwise associated with the vehicle; receiving the vehicle electronics configuration information from the one or more remote computers in response to sending the vehicle identification information; and updating one or more vehicle system modules (VSMs) of the vehicle electronics using the vehicle electronics configuration information.

According to various embodiments, this method may further include any one of the following features or any technically-feasible combination of some or all of these features:
the vehicle electronics configuration information includes one or more updated audio parameters, wherein the updating step includes updating corresponding audio parameters using the one or more updated audio parameters;
the one or more VSMs are configured to carry out vehicle-device functionality, and wherein the vehicle-device functionality employs the one or more updated audio parameters;
the one or more updated audio parameters are selected to be included in the vehicle electronics configuration information based on one or more properties of an interior cabin of the vehicle;
the properties of the interior cabin of the vehicle includes one or more acoustic properties of the interior cabin of the vehicle; and/or
the mobile device software version includes a version of an operating system of the mobile device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flowchart of an embodiment of a method of configuring vehicle electronics of a vehicle for compatibility with a mobile device.

### DETAILED DESCRIPTION

The system and method described below may be used to update or otherwise configure vehicle electronics of a vehicle to be compatible with a mobile device (e.g., smartphone, other handheld wireless device (HWD)) so that vehicle-device functionality can be carried out in an improved manner. Many mobile devices are connected to the Internet (or remote networks) and can be periodically updated via receiving software updates over the Internet. These mobile device updates can include updating one or more features of the mobile device that are used for carrying out vehicle-device functionality. For example, when audio processing of the mobile device is updated, the audio processing and/or handling may change. This can affect the operation of certain audio-related vehicle-device functionality, such as hands-free calling. Thus, the vehicle electronics can be updated in view of the mobile device update and based on information pertaining to the mobile device update. In this way, the vehicle electronics can maintain or improve execution of vehicle-device functionality when the mobile device is updated.

In one embodiment, the mobile device can query the vehicle electronics of the vehicle for vehicle identification information. This can be carried out by the mobile device sending a vehicle identification request message to the vehicle electronics via a local data connection (e.g., Bluetooth™ connection, Wi-Fi™ connection, or universal serial bus (USB) connection). Then, the vehicle can send the vehicle identification information to the mobile device, which can then send the vehicle identification information and mobile device identification information of the mobile device to a remote facility (or one or more remote servers). The remote facility can then determine vehicle electronics configuration information based on the vehicle identification information and the mobile device identification information and, subsequently, send the vehicle electronics configuration information to the vehicle via the mobile device or directly. This vehicle electronics configuration information can be selected or determined based on various properties of the vehicle and the mobile device, such as an acoustic profile (or acoustic properties) of the vehicle (which can be based on the vehicle's trim package) and an operating system version of the mobile device. The vehicle electronics can then configure one or more vehicle system modules (VSMs) of the vehicle electronics to operate according to the vehicle electronics configuration information.

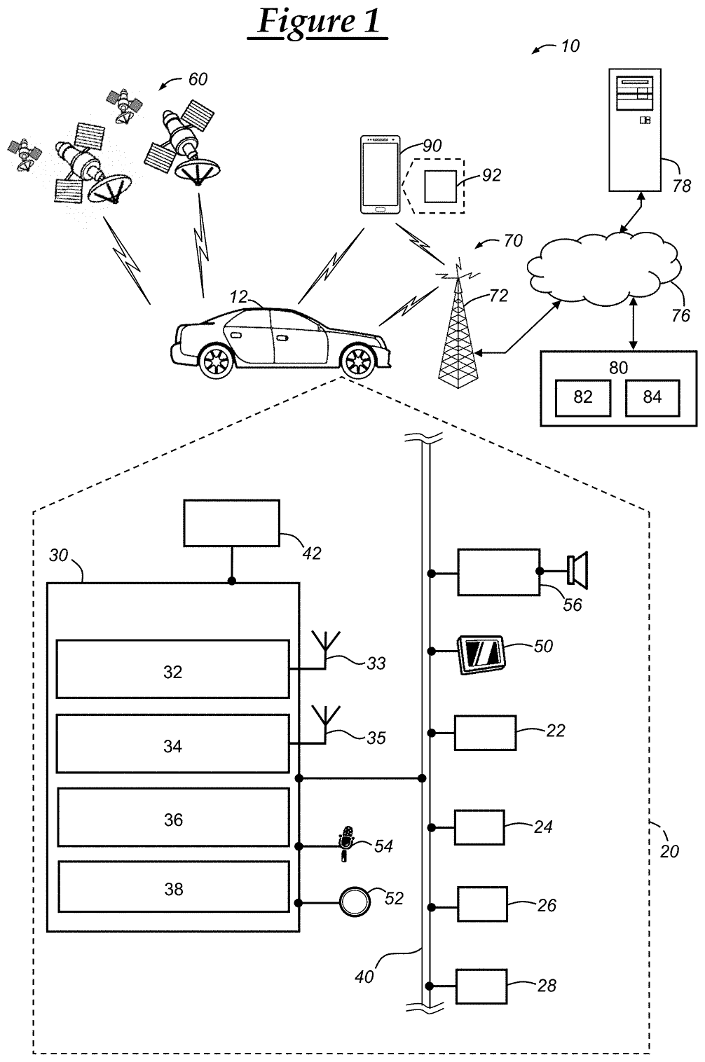

With reference to FIG. 1, there is shown an operating environment that comprises a communications system 10 and that can be used to implement the method disclosed herein. Communications system 10 generally includes a vehicle 12 with a wireless communications device 30 and other VSMs 22-56, a constellation of global navigation satellite system (GNSS) satellites 60, one or more wireless carrier systems 70, a land communications network 76, a computer or server 78, a vehicle backend services facility 80, and a handheld wireless device (HWD) 90. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Some of the vehicle electronics 20 are shown generally in FIG. 1 and includes a global navigation satellite system (GNSS) receiver 22, a body control module or unit (BCM) 24, an engine control module (ECM) 26, other vehicle system modules (VSMs) 28, the wireless communications device 30, data port 42, and vehicle-user interfaces 50-56. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, the BCM 24, the ECM 26, the wireless communications device 30, data port 42, and the vehicle-user interfaces 50-56, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 can be connected by communications bus 40 to the other VSMs, as well as to the wireless communications device 30, and can be programmed to run vehicle system and subsystem diagnostic tests. Moreover, each of the VSMs can include and/or be communicatively coupled to suitable hardware that enables intra-vehicle communications to be carried out over the communications bus 40; such hardware can include, for example, bus interface connectors and/or modems. One or more VSMs 28 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites 60. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22.

GNSS receiver 22 may be used to provide navigation and other position-related services to the vehicle operator. Navigation information can be presented on the display 50 (or other display within the vehicle) or can be presented verbally such as is done when supplying turn-by-turn navigation. The navigation services can be provided using a dedicated in-vehicle navigation module (which can be part of GNSS receiver 22 and/or incorporated as a part of wireless communications device 30 or other VSM), or some or all navigation services can be done via the vehicle communications device (or other telematics-enabled device) installed in the vehicle, wherein the position information is sent to a remote location for purposes of providing the vehicle with navigation maps, map annotations (points of interest, restaurants, etc.), route calculations, and the like. The position information can be supplied to the vehicle backend services facility 80 or other remote computer system, such as computer 78, for other purposes, such as fleet management and/or for use in a car sharing service. Also, new or updated map data can be downloaded to the GNSS receiver 22 from the remote facility 80 via the wireless communications device 30.

Body control module (BCM) 24 can be used to control various VSMs of the vehicle, as well as obtain information concerning the VSMs, including their present state or status, as well as sensor information. The BCM 24 is shown in the exemplary embodiment of FIG. 1 as being electrically coupled to the communication bus 40. In some embodiments, the BCM 24 may be integrated with or part of a center stack module (CSM) and/or integrated with wireless communications device 30. Or, the BCM may be a separate device that is connected to other VSMs via bus 40. The BCM 24 can include a processor and/or memory, which can be similar to processor 36 and memory 38 of wireless communications device 30, as discussed below. The BCM 24 may communicate with wireless device 30 and/or one or more vehicle system modules, such as the engine control module (ECM) 26, audio system 56, or other VSMs 28. Software stored in the memory and executable by the processor enables the BCM to direct one or more vehicle functions or operations including, for example, controlling central locking, air conditioning, power mirrors, controlling the vehicle primary mover (e.g., engine, primary propulsion system), and/or controlling various other vehicle modules. For example, the BCM 24 can send signals to other VSMs, such as a request to perform a particular operation or a request for vehicle sensor data and, in response, the sensor may then send back the requested information. And, the BCM 24 may receive vehicle sensor data from VSMs, including battery sensor data or other sensor data from one or more onboard vehicle sensors, and various other information or data from other VSMs. Additionally, the BCM 24 may provide vehicle state information corresponding to the vehicle state of certain vehicle components or systems, including the VSMs discussed herein. For example, the BCM 24 may provide the device 30 with information indicating whether the vehicle's ignition is turned on (as received from ECM 26, for example), the gear the vehicle is presently in (i.e. gear state), and/or other information regarding the vehicle.

Engine control module (ECM) 26 may control various aspects of engine operation such as fuel ignition and ignition timing. The ECM 26 is connected to the communications bus 40 and may receive operation instructions (or vehicle commands) from the BCM 24 or other vehicle system modules, such as the wireless communications device 30 or other VSMs 28. In one scenario, the ECM 26 may receive a command from the BCM to start the vehicle—i.e., initiate the vehicle ignition or other primary propulsion system (e.g., a battery powered motor). In at least some embodiments when the vehicle is a hybrid or electric vehicle, a primary propulsion control module can be used instead of (or in addition to) the ECM 26, and this primary propulsion control module can be used to obtain status information regarding the primary mover (including electrical motor(s) and battery information).

The vehicle 12 can include various onboard vehicle sensors, which includes certain vehicle-user interfaces 50-54 that can be utilized as onboard vehicle sensors. Generally, the sensors can obtain vehicle sensor data, which can include vehicle sensor values as measured or determined by the onboard vehicle sensor. Other information pertaining to either the operating state of the vehicle (the “vehicle operating state”) or the environment of the vehicle (the “vehicle environmental state”) can also be obtained or may be included in the vehicle sensor data. The vehicle sensor data can be sent to other VSMs, such as BCM 24 and the vehicle communications device 30, via communications bus 40. Also, in some embodiments, the vehicle sensor data can be sent with metadata, which can include data identifying the sensor (or type of sensor) that captured the vehicle sensor data, a timestamp (or other time indicator), and/or other data that pertains to the vehicle sensor data or vehicle sensor. The “vehicle operating state” refers to a state of the vehicle concerning the operation of the vehicle, which can include the operation of the primary mover (e.g., a vehicle engine, vehicle propulsion motors). The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle.

Wireless communications device 30 is capable of communicating data via short-range wireless communications (SRWC) and/or via cellular network communications through use of a cellular chipset 34, as depicted in the illustrated embodiment. In one embodiment, the wireless communications device 30 is a central vehicle computer that is used to carry out at least part of the method discussed below. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), body control module (BCM) 24, an infotainment module, a head unit, and/or a gateway module. In some embodiments, the device 30 can be implemented as an OEM-installed (embedded) or aftermarket device that is installed in the vehicle. In one embodiment, the wireless communications device 30 can be or include a telematics unit (or telematics control unit) that is capable of carrying out cellular communications using one or more cellular carrier systems 70. Or, in other embodiments, a separate telematics unit can be included in the vehicle and communicatively coupled to the wireless communications device 30 directly and/or via the communications bus 40. Also, in some embodiments, the wireless communications device 30 and/or the telematics unit can be integrated with the GNSS receiver 22 so that, for example, the GNSS receiver 22 and the wireless communications device 30 (or telematics unit) are directly connected to one another as opposed to being connected via communications bus 40.

In some embodiments, the wireless communications device 30 can be configured to communicate wirelessly according to one or more short-range wireless communications (SRWC) such as any of the Wi-Fi™, WiMAX™, Wi-Fi Direct™, IEEE 802.11p, other vehicle to vehicle (V2V) communication protocols, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals. The SRWC circuit 32 may allow the device 30 to connect to another SRWC device, such as the HWD 90. Additionally, in some embodiments, the wireless communications device 30 contains cellular chipset 34 thereby allowing the device to communicate via one or more cellular protocols, such as those used by cellular carrier system 70. In such a case, the wireless communications device becomes user equipment (UE) usable in carrying out cellular communications via cellular carrier system 70.

The wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may be a non-transitory computer-readable medium, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. The wireless communications device 30 can interface various VSMs of the vehicle 12 with one or more devices external to the vehicle 12, such as one or more networks or systems at remote facility 80 or the HWD 90.

Data port 42 can be any type of port that can be used to provide power from a vehicle battery. The data port 42 can be a universal serial bus (USB) port, an Ethernet (IEEE 802.3) port, an onboard diagnostics port (e.g., OBD II port), and/or various other ports or connectors that can be used for hardwired data transmissions. For example, the data port 42 can be a female USB connector that can be configured to receive a male USB connector from a USB cable or other USB device, such as a USB dongle. Various USB types can be used, including USB type A, type B, micro-B, mini-B, and/or type C. These USB connectors may also be USB 2.0 or 3.0 connectors. In one embodiment, the data port 42 may be used to provide power to a connected device, such as the HWD 90. The data port 42 can be supplied power from the vehicle battery, such as at times when the vehicle is in a powered on state. The data port 42 is depicted as being directly connected to the wireless communications device 30; however, in some embodiments, the data port 42 can be alternatively or additionally connected to the bus 40 and/or other VSMs.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. Vehicle-user interfaces 50-54 are also onboard vehicle sensors that can receive input from a user or other sensory information and that can obtain vehicle sensor data for use in various embodiments of the method(s) below. The pushbutton(s) 52 allow manual user input into the communications device 30 to provide other data, response, and/or control input (e.g., a windshield wiper activation or control switch). Audio system 56 is an audio-related VSM and provides audio output to a vehicle occupant and can be a dedicated, stand-alone system or part of the primary vehicle audio system. According to a particular embodiment, audio system 56 is operatively coupled to both vehicle bus 40 and an entertainment bus (not shown) and can provide AM, FM and satellite radio, CD, DVD and other multimedia functionality. This functionality can be provided in conjunction with or independent of an infotainment module. Microphone 54 an audio-related VSM and provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, or a projector that can project graphics for viewing by a vehicle occupant. Various other vehicle-user interfaces can also be utilized, as the interfaces of FIG. 1 are only an example of one particular implementation.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with a vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The computers 78 (only one shown) can be some of a number of computers accessible via a private or public network such as the Internet. And, the computers 78 (only one shown in FIG. 1) can be used for one or more purposes, such as for providing information regarding mobile devices. In some embodiments, the computers 78 can be a third-party computer or server that provides audio processing information for one or more mobile devices. This audio processing information can specify one or more audio parameters, protocols, or other information that is used by certain mobile devices for processing audio, including sampling audio and/or outputting audio. The audio processing information can be associated with particular types of devices (e.g., makes, models) as well as software versions for those devices. In one embodiment, the software versions can be versions for the operating system (OS) of various mobile devices, such as certain iOS™ or Android™ version numbers (or other identifiers).

Other such accessible computers 78 can be, for example: a service center computer where diagnostic information and other vehicle data can be uploaded from the vehicle; a client computer used by the vehicle owner or other subscriber for various purposes, such as accessing and/or receiving vehicle sensor data (or other data), as well as setting up and/or configuring subscriber preferences or controlling vehicle functions; a car sharing server which coordinates registrations from a plurality of users who request to use a vehicle as part of a car sharing service; or a third party repository to or from which vehicle sensor data or other information is provided, whether by communicating with the vehicle 12, remote facility 80, or both. A computer 78 can also be used for providing Internet connectivity such as DNS services or as a network address server that uses DHCP or other suitable protocol to assign an IP address to vehicle 12.

Vehicle backend services facility 80 is a remote facility, meaning that it is located at a physical location that is located remotely from vehicle 12. The remote facility 80 includes one or more servers 82 and one or more databases 84. The vehicle backend services facility 80 (or “remote facility 80” for short) may be designed to provide the vehicle electronics 20 with a number of different system back-end functions through use of one or more electronic servers. The remote facility 80 includes vehicle backend services servers and databases, which may be stored on a plurality of memory devices. Also, remote facility 80 can include one or more switches, one or more live advisors, and/or an automated voice response system (VRS), all of which are known in the art. The remote facility 80 may include any or all of these various components and, preferably, each of the various components are coupled to one another via a wired or wireless local area network. The remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Remote facility 80 can use the information stored in databases to carry out one or more embodiments of the method(s) discussed herein. Although only a single vehicle backend services facility 80 is illustrated, numerous vehicle backend services facilities can be used and, in such a case, the functionality of the numerous vehicle backend services facilities can be coordinated so that the vehicle backend services facilities can act as a single backend network or so that the operation of each facility is coordinated with the operation of the other facilities. And, the servers can be used to provide information stored in the databases to various other systems or devices, such as vehicles 12 or the HWD 90.

The remote facility 80 can include one or more databases 84 that can be stored on a plurality of memory. The databases 84 can include a vehicle electronics configuration database that can store information or data used to configure vehicle electronics of a vehicle. The vehicle electronics configuration database can include one or more operating parameters, which can include one more vehicle-device operating parameters. In some embodiments, the vehicle-device operating parameters can be associated with a type of mobile device and/or a version number of a mobile device. The remote facility 80 can send vehicle-device operating parameters to the vehicle (via the HWD 90) so that the vehicle electronics 20 can become configured to operate according to the vehicle-device operating parameters, which can be tuned, selected, or otherwise configured for carrying out vehicle-device functionality between a particular mobile device and a particular vehicle. The particular mobile device can be identified by the HWD 90 sending mobile device identification information to the remote facility 80. Likewise, the particular vehicle can be identified by the HWD 90 sending vehicle identification information to the remote facility 80. In other embodiments, the vehicle 12 can directly send this information to the remote facility 80. Based on this mobile device identification information and this vehicle identification information, the remote facility 80 can query databases 84 for vehicle-device operating parameters that correspond or are tailored to the particular mobile device and/or the particular vehicle.

A “vehicle-device operating parameter” is information, settings, or other data that is used to configure the vehicle electronics for carrying out various vehicle-device functionality. “Vehicle-device functionality” includes functionality that is carried out using both a mobile device (e.g., HWD 90) and the vehicle electronics. For example, a hands-free call that is carried out for the HWD 90 using one or more vehicle-user interfaces is a vehicle-device function that constitutes vehicle-device functionality. As another example, streaming music from the HWD 90 to the audio system 56 of the vehicle electronics 20 is a vehicle-device function that constitutes vehicle-device functionality. In one embodiment, the vehicle-device operating parameter(s) can be vehicle electronics audio parameters. For example, these audio parameters can include echo cancellation (EC) or noise reduction (NR) parameters. These audio parameters can be based on the operating system of the mobile device (as obtained based on the mobile device identification information) and the software of the vehicle electronics. Also, alternatively or additionally, these audio parameters (or other vehicle-device operating parameters) can be selected or derived based on properties of the vehicle (as obtained based on the vehicle identification information). These vehicle properties can be properties of the vehicle electronics (e.g., hardware or software properties), properties of the interior cabin of the vehicle (e.g., vehicle trim type or other trim properties), and/or properties of the vehicle. In one embodiment, the audio parameters can be selected based on the acoustic properties of an interior cabin of the vehicle—in such a case, the trim properties can be identified based on querying the databases 84 for vehicle property information (or vehicle properties) based on the vehicle identification information, which can be a vehicle identification number (VIN) or other identifying information. The acoustic properties of the interior cabin of the vehicle (or other parts of the vehicle) can be referred to as an acoustic profile. In one embodiment, the vehicle information stored in databases 84 can include information concerning various vehicle system modules (VSMs) and/or electronic architectures of various vehicles. Moreover, this information can be associated with a corresponding vehicle (or type of vehicle) and, also, this association can be stored in the vehicle feature information databases 84.

The handheld wireless device (HWD) 90 is a mobile device and a SRWC device (i.e., a device capable of SRWC) and may include: hardware, software, and/or firmware enabling cellular telecommunications and SRWC as well as other mobile device applications, such as a vehicle management application 92. The hardware of the HWD 90 may comprise: a processor and memory for storing the software, firmware, etc. The processor and memory of the HWD 90 can be any of those types as discussed with respect to processor 36 and memory 38 of the wireless communications device 30. The HWD processor and memory may enable various software applications, which may be preinstalled or installed by the user (or manufacturer) (e.g., having a software application or graphical user interface (GUI)). In one embodiment, the application 92 enables a vehicle user to communicate with the vehicle 12 and/or control various aspects or functions of the vehicle, some of which are listed above. Additionally, one or more applications may allow the user to connect with the remote facility 80 or call center advisors at any time. The application 92 can also provide a user interface for controlling various vehicle functionality. As mentioned below, in one embodiment, the application can be used to carry out one or more steps of the method discussed below.

In one particular embodiment, the HWD 90 can be a personal cellular SRWC device that includes a cellular chipset and/or cellular connectivity capabilities, as well as SRWC capabilities. Using a cellular chipset, for example, the HWD can connect with various remote devices, including computers 78 and remote server facility 80, via wireless carrier system 70. As used herein, a personal SRWC device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC. In some embodiments, the HWD 90 is a personal SRWC device.

The processor of the HWD 90 can be any type of device capable of processing electronic instructions including microprocessors, microcontrollers, host processors, controllers, vehicle communication processors, and application specific integrated circuits (ASICs). The processor executes various types of digitally-stored instructions, such as software or firmware programs stored in memory of the HWD 90, which enable the device 90 to provide a wide variety of functionality. For instance, in one embodiment, the processor can execute programs (e.g., the vehicle management application 92) or process data. In some embodiments, the HWD 90 can be a smartphone or tablet that includes an operating system, such as Android™, iOS™, Microsoft Windows™, and/or other operating systems. The memory of the HWD 90 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), or magnetic or optical disc drives. In one embodiment, the memory of HWD 90 may be a non-volatile memory card, such as a Secure Digital™ (SD) card, that is inserted into a card slot of HWD 90. In one embodiment, the memory of the HWD 90 can store mobile device identification information, which (in some embodiments) can specify a mobile device operating system and version number.

The HWD 90 can also include a short range wireless communications (SRWC) circuit and/or chipset as well as one or more antennas, which allows it to carry out SRWC, such as any of the IEEE 802.11 protocols, Wi-Fi™, WiMAX™, ZigBee™, Wi-Fi Direct™, Bluetooth™, or near field communication (NFC). The SRWC circuit and/or chipset may allow the HWD 90 to connect to another SRWC device. Additionally, as mentioned above, the HWD 90 can include a cellular chipset thereby allowing the device to communicate via one or more cellular protocols, such as GSM/GPRS technology, CDMA or CDMA2000 technology, and LTE technology. The HWD 90 may communicate data over wireless carrier system 70 using the cellular chipset and an antenna. In many embodiments, the HWD 90 can be an HWD of a vehicle user and can include a vehicle management application 92, as depicted in the illustrated embodiment of FIG. 1. In one embodiment, the HWD 90 can include a USB port (or other data port) that is able to connect with a USB cable (or other data cable) so that a hardwired data connection can be established between the HWD 90 and the vehicle electronics via the data port 42.

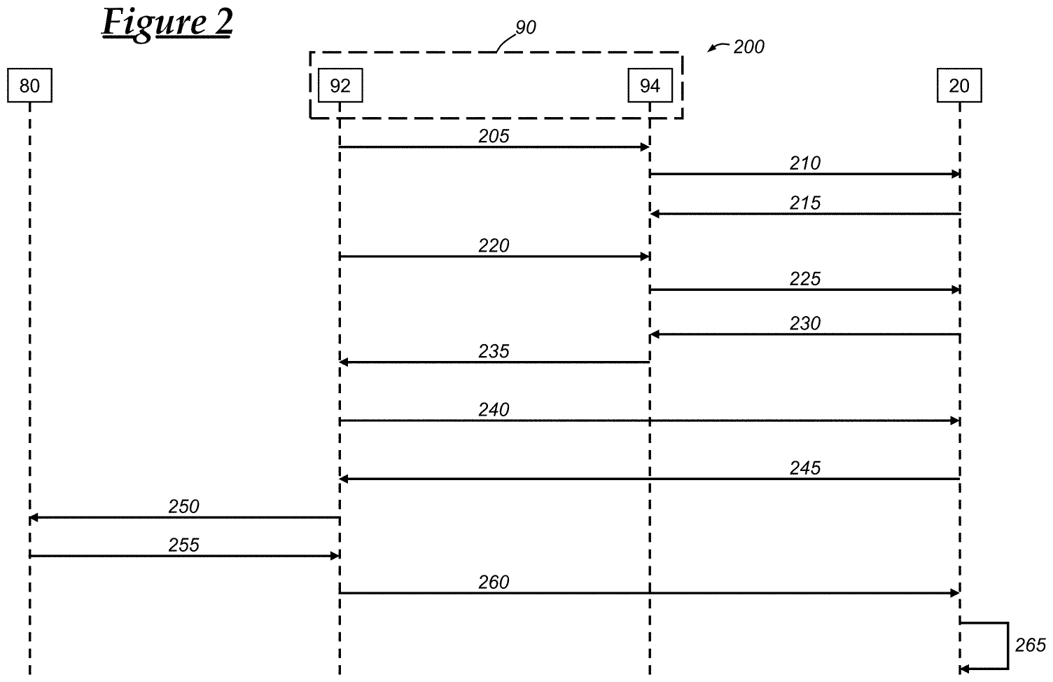

With reference to FIG. 2, there is shown an embodiment of a method 200 of method of configuring vehicle electronics of a vehicle for compatibility with a mobile device. Although the steps of the method 200 are described as being carried out in a particular order, it is hereby contemplated that the steps of the method 200 can be carried out in any suitable order as will be appreciated by those skilled in the art.

The method 200 depicts communications between the remote facility 80, the vehicle management application 92 of the HWD 90, other software 94 of the HWD 90, and the vehicle electronics 20. In one embodiment, the other software 94 is an operating system of the HWD 90 and will be referred to as the operating system 94. The method 200 begins with step 205, wherein a vehicle management application (e.g., application 92) is installed to the mobile device (e.g., HWD 90). This step is illustrated as an arrow extending from the application 92 to the operating system 94. In one embodiment, the vehicle management application 92 can be downloaded from a remote computer (e.g., computers 78, computers at remote facility 80) to the HWD 90 and then installed on the HWD 90. For example, a user of the HWD 90 can navigate to a download/installation page for the vehicle management application 92 using a digital distribution platform for computer software, such as the “App Store” (iOS™) or the Play Store (Android™). The user can then select a download or install button for the vehicle management application 92, which then causes the HWD 90 to download and install software representing the vehicle management application 92. The method 200 continues to step 210.

In steps 210 and 215, the mobile device establishes a local data connection to the vehicle electronics. This step can include establishing a short-range wireless communications (SRWC) connection between the HWD 90 and the wireless communications device 30 of the vehicle 12. For example, the SRWC circuit 32 of the wireless communications device 30 and a SRWC circuit of the HWD 90 can carry out a Bluetooth™ (e.g., Bluetooth™ Low Energy (BLE)) establishment process so that a secured wireless connection is established between the HWD 90 and the vehicle electronics 20. In another embodiment, a hardwired connection can be established, which can include connecting the vehicle electronics 20 to the HWD 90 via a Universal Serial Bus (USB) cable that extends from the HWD 90 (e.g., a data port of the HWD 90) and the data port 42 of the vehicle electronics 20. In one particular embodiment, the HWD 90 can send a connection request message (step 210) and, in response, the vehicle electronics 20 can send a connection acknowledgement (or confirmation) message (step 215).

In one embodiment, the vehicle electronics 20 and the HWD 90 can automatically initiate the establishment process for establishing a local data connection. For example, the vehicle electronics 20 and the HWD 90 may be previously paired or bonded devices that each stores connection information for use in establishing a secure local data connection (e.g., a BLE connection) with one another. Upon one of these devices detecting the other (e.g., the wireless communications device 30 detecting the presence of the HWD 90), then a connection establishment process can be carried out.

As depicted in the illustrative embodiment of FIG. 2, steps 210 and 215 are carried out (at least in part) by the operating system 94 of the HWD 90. In one embodiment, the operating system 94 (or other software of the HWD 90 that is not a part of the vehicle management application 92) can establish a SRWC using standard or baseline SRWC protocols, such as various Bluetooth™ or Wi-Fi™ protocols. In one embodiment, these protocols come preinstalled on the HWD 90. This wireless local data connection can use an encrypted channel in which communications between the operating system 94 and the vehicle electronics 20 are encrypted. This local data connection can use those encryption (and/or other security techniques) that are provided by the standard SRWC protocol. This encryption or security layer of the local data connection provides a first layer of security for data transmissions. The method 200 continues to step 220.

In steps 220-235, the vehicle management application establishes a private data channel over the local data connection. The private data channel is used to provide communications between the vehicle management application 92 and the wireless communications device 30 of the vehicle electronics 20. The vehicle management application 92 and the wireless communications device 30 can use encryption and/or other security techniques to secure communications over the local data connection. Thus, in at least some embodiments, the private data channel provides a second layer of security that is separate from the first layer of security. In one embodiment, this private data channel enables communications to be secured such that the operating system 94 (or other applications besides application 92) of the HWD 90 cannot access the underlying data since the encryption key(s) (or other security information) are only known (at least in some embodiments) to the application 92 and the other end device or module of the private data channel, which can be the wireless communications device 30 (or other VSM) and/or an application installed thereon. The private data channel can use private data channel security information (e.g., encryption keys) that are sent to the vehicle electronics 20 and the HWD 90. This private data channel security information can be sent via the remote facility 80. Thus, communications over the private data channel are first encrypted using the private data channel security layer and, then, this encrypted data is then encrypted again using the local data connection security layer; other security techniques can also be used as well. In one embodiment, either or both of these security layers can use application level encryption. In some embodiments, such as when a hardwired data connection is used for the local data connection, only the private data channel security layer may be used to encrypt or otherwise secure the data being communicated, or no encryption may be used at all.

In a particular embodiment, the application 92 sends a private data channel request message to the vehicle electronics via the local data connection (step 220 and 225). The vehicle electronics 20 (or wireless communications device 30) can then send a private data channel confirmation message (step 230 and 235) that confirms (or denies) the establishment of the private data channel. It should be appreciated that establishing the private data channel can include a different number or order of steps—for example, the vehicle electronics 20 can initiate the private data channel establishment process. The method 200 then continues to step 240.

In step 240, a vehicle identification request message is sent from the mobile device to the vehicle electronics. In many embodiments, the application 92 queries the vehicle electronics for vehicle identification information by sending the vehicle identification request message to the vehicle electronics over the local data connection. And, in at least some embodiments, this vehicle identification request message is sent over the private data channel. This vehicle identification request message can include information that indicates to the vehicle electronics to provide vehicle identification information and, in some embodiments, can request or indicate a certain type of vehicle identification information. The vehicle identification information can be any information that uniquely identifies the vehicle, the vehicle's model and/or model year, the trim of the vehicle, the vehicle electronics type or version, and/or other property of the vehicle. The method 200 then continues to step 245.

In step 245, the vehicle identification information is sent from the vehicle electronics to the mobile device via the local data connection. In at least some embodiments, the vehicle identification information is sent over the private data channel. This vehicle identification information can be embodied in a vehicle identification response message that is sent in response to the vehicle electronics receiving the vehicle identification request message (step 230). The method 200 then continues to step 250.

In step 250, the mobile device sends vehicle identification information and/or mobile device identification information from the mobile device to a remote facility. The vehicle identification information can be the vehicle identification information that was received in step 245. The mobile device identification information can be information that uniquely identifies the particular mobile device (or HWD 90) (e.g., a media access control (MAC) address), an operating system version, a version of a particular software module of the mobile device, or other information that identifies properties of the software and/or hardware of the mobile device. In one embodiment, the mobile device identification information is stored on memory of the HWD 90. The mobile device identification information and the vehicle identification information can be sent in the same message or different messages (at the same or different times) to the remote facility 80. The method 200 then continues to step 255.

In step 255, the mobile device receives vehicle electronics configuration information from the remote facility. In many embodiments, vehicle electronics configuration information is or includes vehicle-device operating parameters. In at least some embodiments, the vehicle-device operating parameters are selected or otherwise obtained based on the mobile device identification information and/or the vehicle identification information. For example, the vehicle-device operating parameters can be stored in databases 84 of remote facility 80 and associated with certain vehicles, vehicle models, vehicle trims (e.g., trims for a particular model), vehicle acoustic profiles, vehicle model years, vehicle makes, vehicle electronics architecture or properties, VSM version(s), or any combination thereof. Also, the vehicle-device operating parameters can be associated in a like manner with properties of the mobile device, which can be identified based on the mobile device identification information. In one embodiment, the remote facility 80 can query another computer, such as a remote computer (e.g., computer 78), for information pertaining to a particular mobile device or a mobile device of a particular type (e.g., a particular operating system version).

In one embodiment, the mobile device receives one or more audio parameters from the remote facility. The one or more audio parameters can be vehicle-device operating parameters, and can be configured such that, when the vehicle is updated with the one or more audio parameters (step 265), one or more audio-related VSMs or functions of the vehicle operate in an improved manner when carrying out vehicle-device functionality. Examples of audio parameters include noise reduction (NR) parameters and echo cancellation (EC) parameters. The audio parameters can be tailored based on one or more vehicle properties and/or one or more mobile device properties, such as the vehicle trim (or acoustic profile) and vehicle model as well as properties of the mobile device audio hardware or audio processing, which can be determined through inspection of the mobile device operating system version, for example. In some embodiments, the remote facility can obtain information regarding the mobile devices from a third-party server that can be hosted remotely, such as at computer(s) 78. The method 200 then continues to step 260.

In step 260, the vehicle electronics configuration information is sent to the vehicle from the HWD 90 via the local data connection. In at least some embodiments, the vehicle electronics configuration information is sent to the vehicle via the private data channel. And, in some embodiments, sending the vehicle electronics configuration information to the vehicle results in one or more vehicle system modules (VSMs) of the vehicle electronics to become configured to operate according to the vehicle electronics configuration information, which can be one or more audio parameters, as discussed above. The method 200 then continues to step 265.

In step 265, the vehicle electronics is configured according to the vehicle electronics configuration information. In one embodiment, before step 265 is carried out, the vehicle electronics can be configured to operate according to (or using) vehicle-device operating parameters that are to be updated, replaced, or modified using vehicle-device operating parameters received from the HWD 90. These already-installed vehicle-device operating parameters can be referred to as corresponding vehicle-device operating parameters. In one embodiment, these corresponding (or already-installed) vehicle-device operating parameters can be default vehicle-device operating parameters (or default vehicle operating parameters). The vehicle electronics 20 can be preconfigured or manufactured with these default parameters. In another embodiment, these existing or corresponding vehicle-device operating parameters can be vehicle-device operating parameters that were installed to the vehicle during a prior iteration of the method 200.

In one embodiment, the vehicle electronics configuration information can include values that constitute the one or more vehicle operating parameters. These parameter values can be used to replace previous or corresponding parameter values in memory of the vehicle electronics, such as in memory 38 of the wireless communications device 30. Alternatively or additionally, the vehicle electronics configuration information can include computer instructions that are executable by a processor of the vehicle electronics, such as processor 36 of the wireless communications device 30. These computer instructions can be stored in memory (e.g., memory 38, memory of another VSM) and can replace existing or corresponding computer instructions. The method 200 then ends.

In some embodiments, the method 200 can use only the local data connection without a private data channel over the local data channel. In one embodiment, such as when only the local data connection is used, only a single security layer may be used for communications between the application 92 and the vehicle electronics 20. In some embodiments, the remote facility 80 can send the application 92 encryption key(s) (or other security information) for securing communications between the application 92 and the vehicle electronics 20 via the private data channel. The encryption key(s) (or other security information) can be sent from the remote facility 80 to the vehicle electronics 20 as well.

In at least some embodiments, step 220 (and/or any of the consecutive steps) can be carried out in response to a trigger event. In one embodiment, the trigger event can include detecting that an operating system of the mobile device (e.g., HWD 90) has been (or is being) updated, or that another software module of the mobile device has been (or is being) updated. Furthermore, in some embodiments, the application 92 can determine that the vehicle electronics is not configured for use with the mobile device or for use with the current version of the operating system of the mobile device. The mobile device can store information that indicates whether the vehicle electronics have been updated to be compatible with the mobile device. In some embodiments, this stored information can indicate whether the vehicle electronics have been updated to be compatible with one or more particular functions of the mobile device, such as audio-related functions, which can include hands-free calling (e.g., using vehicle microphone(s) 54 and/or audio system 56 to carry out a call for the mobile device) and/or streaming audio from the mobile device to the audio system of the vehicle (e.g., audio system 56).

In other embodiments, the mobile device sends mobile device identification information to the vehicle electronics, and the vehicle electronics sends the received mobile device identification information and vehicle identification information to the remote facility. The remote facility can then send vehicle electronics configuration information back to the vehicle electronics and the vehicle electronics can carry out the configuration process of step 265. Also, the vehicle electronics or the remote facility can then inform the mobile device of the status or version of the vehicle electronics, including the status or version of one or more VSMs of the vehicle electronics.

In at least some embodiments, the vehicle electronics can include a central computer (e.g., wireless communications system 30) that performs the vehicle electronics configuration process of step 265. This central computer can include software that is configured to receive the vehicle electronics configuration information and then reprograms or otherwise updates the vehicle electronics using the vehicle electronics configuration information. In another embodiment, the vehicle electronics configuration process can be carried out for a particular VSM and, when the vehicle electronics configuration information is received, the central computer can send at least part of the vehicle electronics configuration information to the particular VSM, which can then perform the configuration or updating process. In one embodiment, the vehicle electronics configuration information can specify one or more VSMs to which the vehicle electronics configuration information pertains. Or, this information that specifies the one or more VSMs can be separately sent to the vehicle electronics from the mobile device or the remote facility.

In one embodiment, one or more remote servers, which can be located at a single remote facility or at multiple remote facilities, receives vehicle identification information of the vehicle and mobile device identification information of the mobile device. The mobile device and the vehicle can be paired or otherwise associated with one another. Then, the one or more remote servers can query one or more databases for one or more updated audio parameters based on the vehicle identification information and a mobile device version (or other information) as indicated by the mobile device identification information. As mentioned above, the selected audio parameters (or other vehicle-device operating parameters) can be tailored to the particular mobile device and/or the particular vehicle. In one embodiment, the audio parameters are selected or derived based on both the particular mobile device and the particular vehicle. For example, the audio parameters are selected based on a current operating system version of the mobile device and one or more vehicle properties, which can include one or more properties of the vehicle electronics (e.g., software versions) as well as one or more physical properties of the vehicle, such as an acoustic profile of an interior cabin. Once the audio parameters (or other vehicle-device operating parameters) are selected, these parameters can be sent to the vehicle via the mobile device or directly (i.e., without sending the parameters via the mobile device). The vehicle then receives these updated parameters, which causes the vehicle to configure the vehicle electronics of the vehicle. The vehicle can then install or otherwise update corresponding audio parameters (or other vehicle-device operating parameters) using the received parameters. As mentioned above, in some embodiments, the vehicle-device operating parameters can be values or may be software that is to be installed to the vehicle. In at least some embodiments, these values or this software can replace existing or corresponding values or software.

In one embodiment, the method 200 and/or parts thereof can be implemented in one or more computer programs (or “applications”, or “scripts”) embodied in a computer readable medium and including instructions usable (e.g., executable) by one or more processors of the one or more computers of one or more systems. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s) can be embodied on computer readable media (e.g., memory at servers 82, memory 38, memory of the BCM 24, memory of the HWD 90, a combination thereof), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of configuring vehicle electronics of a vehicle for compatibility with a mobile device, wherein the method is carried out by the mobile device, the method comprising:
establishing a local data connection with the vehicle electronics so that information is able to be communicated between the vehicle electronics and the mobile device via the local data connection;
sending, over the local data connection, a vehicle identification request message from the mobile device to the vehicle electronics of the vehicle, wherein the vehicle identification request message queries the vehicle electronics of the vehicle for vehicle identification information;
in response to sending the vehicle identification request message, receiving, over the local data connection, the vehicle identification information at the mobile device from the vehicle;
sending the vehicle identification information and mobile device identification information of the mobile device to a remote facility, wherein the mobile device is separate from the vehicle electronics of the vehicle;
receiving vehicle electronics configuration information at the mobile device from the remote facility, wherein the vehicle electronics configuration information is information that is based at least partly on properties of the mobile device and which is selected based on the vehicle identification information and the mobile device identification information, and wherein the vehicle electronics configuration information includes at least one vehicle-device operating parameter; and
causing the vehicle electronics to configure one or more vehicle system modules of the vehicle electronics to operate according to the vehicle electronics configuration information by sending, over the local data connection, the vehicle electronics configuration information from the mobile device to the vehicle electronics.

2. The method of claim 1, wherein the vehicle electronics configuration information includes one or more audio parameters that are used for carrying out one or more audio-related functions of the vehicle electronics, and wherein the one or more audio parameters are based on the vehicle identification information and the mobile device identification information.

3-7. (canceled)

8. The method of claim 1, wherein the mobile device includes a vehicle management application that is used to at least partly carry out the sending the vehicle identification request message step, the receiving the vehicle identification information step, and the sending the vehicle identification information and mobile device identification information step.

9. The method of claim 1, wherein the mobile device identification information includes information that indicates an operating system version of the mobile device.

10. The method of claim 9, wherein the method is carried out in response to determining that the vehicle electronics have yet to be updated for operation with the operating system version of the mobile device.

11-14. (canceled)

15. A method of configuring vehicle electronics of a vehicle for compatibility with a mobile device, wherein the method is carried out by the vehicle electronics of the vehicle, and wherein the method comprises:
sending vehicle identification information of the vehicle to one or more remote computers that are configured to query one or more databases for vehicle electronics configuration information based on the vehicle identification information and a mobile device software version of the mobile device, wherein the mobile device is paired or otherwise associated with the vehicle;
receiving the vehicle electronics configuration information from the one or more remote computers in response to sending the vehicle identification information; and
updating one or more vehicle system modules (VSMs) of the vehicle electronics using the vehicle electronics configuration information, wherein the vehicle electronics configuration information includes one or more updated audio parameters that are selected at least partly based on the mobile device software version of the mobile device, and wherein the updating step includes updating corresponding audio parameters using the one or more updated audio parameters.

16. (canceled)

17. The method of claim 15, wherein the one or more VSMs are configured to carry out vehicle-device functionality, and wherein the vehicle-device functionality employs the one or more updated audio parameters.

18. The method of claim 17, wherein the one or more updated audio parameters are selected to be included in the vehicle electronics configuration information based on one or more properties of an interior cabin of the vehicle.

19. The method of claim 18, wherein the properties of the interior cabin of the vehicle includes one or more acoustic properties of the interior cabin of the vehicle.

20. The method of claim 15, wherein the mobile device software version includes a version of an operating system of the mobile device.
